(19) United States
(12) Patent Application Publication
(10) Pub. No.: US 2012/0044336 A1
(43) Pub. Date: Feb. 23, 2012

(54) Generic Threat Detector

(75) Inventors: Rhalem Zouaoui, Bourg la Reine (FR); Thierry Lamarque, Magny-les-Hameaux (FR); Johan D'Hose, Palaiseau (FR)

(73) Assignee: THALES, Neuilly-sur-Seine (FR)

(21) Appl. No.: 12/978,475

(22) Filed: Dec. 24, 2010

(30) Foreign Application Priority Data
Dec. 30, 2009 (FR) FR0906395

(51) Int. Cl. H04N 7/18; G06F 15/00

(52) U.S. Cl. 348/77; 702/189; 348/E05.024

(57) ABSTRACT

A device including at least one threat detector, which estimates the level of threat represented by an individual based on measurements taken when the individual enters a measurement zone. The device has application to protection of infrastructures.

### CROSS-REFERENCE TO RELATED APPLICATION

This application claims priority to foreign French patent application No. FR 0906395, filed on Dec. 30, 2009, the disclosure of which is incorporated by reference in its entirety.

### FIELD OF THE INVENTION

The present invention relates to a device for estimating the level of threat represented by an individual without the individual collaborating. It applies notably in the field of protection of infrastructures, for example the security walk-through scanners used in airports.

### BACKGROUND

Security walk-through scanners are designed to detect and estimate possible threats that may be represented by individuals.

For example, the metal detectors comprise sensors capable of detecting any metal object carried by an individual. And depending on the quantity of metal detected, the estimated level of threat is more or less high. The millimetric-wave walk-through scanners comprise sensors capable of measuring the natural radiation of the body and therefore of detecting objects hidden under the clothing which would be an obstacle to the natural radiation of the body. And depending on the size and the shape of the detected object, the estimated level of threat is higher or lower. The trace detectors, also called “electronic noses”, are for their part capable of detecting the presence of chemical compounds, notably the precursors of explosives. And depending on the variety and the quantity of precursors detected, the estimated level of threat is more or less high.

One major drawback of these various types of walk-through scanner is that they address only one type of threat at a time. In order to try to tackle the new terrorist threats that are by nature difficult to identify, security systems must today provide multi-threat detection functionalities capable of addressing several types of threat at the same time and of generating the “threat profile” of an individual. But assembling such functionalities within one and the same system makes it necessary to incorporate a large variety of sensors, which is not without many difficulties.

First of all, because the current single-threat detection systems use specific proprietary formats for interchanging the information, whether it involves receiving an order of the start/stop type or else sending to an operator a detection report containing the result of an estimate of a level of threat relating to an individual of whom measurements have been taken. Usually, the operator receives the report via a monitoring system that may notably comprise a display screen. The fact that there are as many message formats as there are types of sensors makes it particularly difficult to incorporate heterogeneous sensors in one and the same multi-threat detection system.

Then, in public places where the crowd is free to come and go as it wishes, the multi-threat detection systems must be effective even in a non-cooperative mode of use, that is to say that the individuals are monitored without them knowing. For example, a multi-threat detection system in an airport may have to take measurements of individuals passing through a narrow corridor at variable speeds of walking slowly, walking quickly, or even at a run. In this spatial configuration, which will be qualified as a “chained” configuration in the rest of the present application, the sensors must take their measurements one after the other of one and the same individual who is travelling along the corridor. Without him knowing, the individual can first of all enter the measurement zone of a metal detector, then immediately afterwards the measurement zone of a trace detector and finally the measurement zone of a millimetric-wave detector. The metal detector and the millimetric-wave detector take only a few tenths of a second to send their reports. The individual is therefore very probably still in the corridor when the metal detector and the millimetric-wave detector send their reports. On the other hand, the trace detector for its part takes several seconds to gather samples on an individual using blowing and sucking devices, analyse the samples and send its report. The individual has then very probably already left the corridor when the trace detector sends it report. Therefore, in a situation involving a considerable flow rate of individuals in the corridor, the supervision system receives reports in disordered bursts, that is to say that the reports corresponding to one and the same individual are not received in the order in which the individual enters the measurement zones of the detectors. The supervision system receives completely mixed reports corresponding to various individuals. It is then very difficult for it to link together the reports corresponding to one and the same individual.

### SUMMARY OF THE INVENTION

The notable object of the invention is to overcome the aforementioned drawbacks of multi-threat detection systems with heterogeneous sensors, notably to regulate the transmission of the reports of detection by the sensors, so that the threat detection systems can finally be used in a non-collaborative mode. For this, the invention proposes notably to send standard detection reports containing the raw measurements, an estimate of the threat and physical signatures of the individual. The invention also proposes to divide the reports into several portions: a first portion sent on exiting the measurement zone and a second portion sent once the detections are completed. Accordingly, the subject of the invention is a device comprising at least one threat detector. The threat detector estimates the level of threat represented by an individual based on measurements taken when the individual goes through a measurement zone.

For example, the device may comprise a presence detector in order to detect the presence of the individual in the measurement zone.

Advantageously, the presence detector may comprise an infrared beam which the individual breaks when he enters the measurement zone and an infrared beam which the individual breaks when he leaves the measurement zone.

In a preferred embodiment, the threat detector may detect metals that can be carried by the individual or traces of precursors in the manufacture of explosives that can be carried by an individual or else objects that can be hidden under the clothing of the individual.

Advantageously, the device may comprise at least one physical-signature detector that can take measurements in the measurement zone in order to recognize the individual if the latter is known in a database of the individuals likely to go through the measurement zone. The database may contain, for each of said individuals, an identifier associated with his physical signature that can be recognized by the physical-signature detector.

For example, the physical-signature detector may be a camera capable of detecting the face of the individual.

In a preferred embodiment, the device can send a report according to a predetermined format irrespective of the type of measurements taken and of the nature of the estimated threat.

Advantageously, the report may contain the raw measurements taken when the individual goes through the measurement zone and the estimated level of threat based on these measurements.

In a preferred embodiment, the report can be sent in several distinct portions so that the transmission of the data can begin before the detections of threat and of physical signature are completed.

In addition to making it possible to construct a multi-threat detection system that can be used in non-cooperative mode, the main advantage of the invention is also that it makes it possible to construct a totally modular multi-threat detection system allowing both “chained” spatial configurations in narrow corridors and dispersed spatial configurations over large areas. Such a multi-threat detection system can therefore be adapted to any arrangement of the places to be protected.

### BRIEF DESCRIPTION OF THE DRAWINGS

Other features and advantages of the invention will appear with the aid of the following description made with respect to appended drawings which represent:

FIG. 1, via a diagram, an example of architecture of a non-collaborative multi-threat detection system;

FIG. 2, via a diagram, an example of architecture of a generic detector according to the invention;

FIG. 3, via a schematic and a timing chart, an example of measurement zone of a generic detector according to the invention;

FIG. 4, via a schematic and via a timing chart, an example of sequential configuration of measurement modules including generic detectors according to the invention;

FIG. 5, via a schematic and via a timing chart, an example of non-sequential configuration of measurement modules including generic detectors according to the invention;

FIG. 6, via a schematic, an example of structure of a generic report according to the invention;

FIG. 7, via a timing chart, examples of detection processes carried out by generic detectors according to the invention placed in sequential configuration;

FIG. 8, via a timing chart, examples of processes for the sending of a generic report by a generic detector according to the invention;

FIG. 9, via a timing chart, an example of the sending, in two portions, by a generic detector, of a generic report according to the invention.

### DETAILED DESCRIPTION

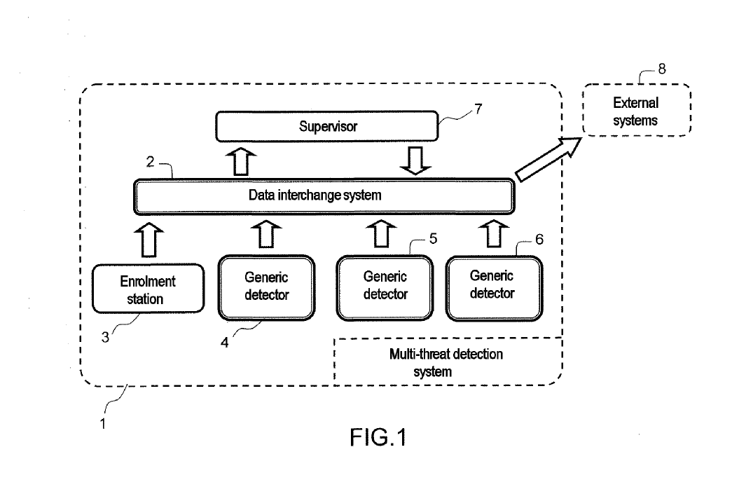

FIG. 1 illustrates via a diagram an example of architecture of a non-collaborative multi-threat detection system 1. The system 1 consists of several elements which communicate by means of a data interchange system 2. The system 1 comprises an enrolment station 3 which supports a database of the individuals likely to be present in the infrastructure to be protected, this database not being shown in FIG. 1. The database notably contains an identifier associated with a physical signature for each registered individual. The system 1 also comprises generic detectors 4, 5 and 6 according to the invention. A generic detector according to the invention combines several physical sensors and automated processing modules for estimating the level of threat based on the measurements taken by the physical sensors. Advantageously, each of the generic detectors 4, 5 and 6 can send to a supervisor 7 generic reports according to the invention, which can notably contain the measurements taken by the physical sensors and the results of estimating the level of threat. The supervisor 7 can inform an operator of the level of threat by display or alarm means. He can if necessary communicate the measurements and the level of threat to appropriate external systems 8.

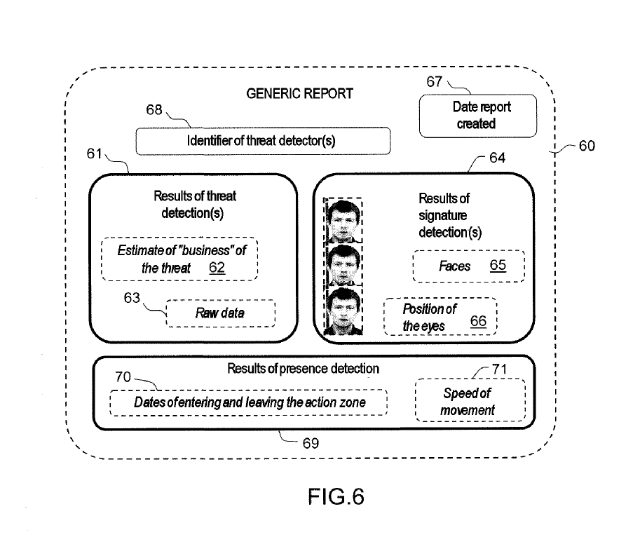

Advantageously, a generic report can be a report with the standard structure and format according to the invention so that, irrespective of the generic detector 4, 5 or 6 that has sent it, the supervisor 7 is capable of interpreting it by the same means. FIG. 6 illustrates the standard structure of a generic report according to the invention. In the rest of the present application, the term “report” will simply be used to designate generic reports sent by generic detectors according to the invention.

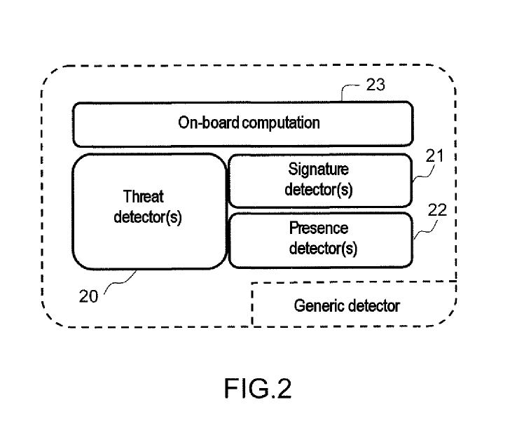

FIG. 2 illustrates, via a diagram, an example of architecture of a generic detector according to the invention, such as the generic detectors 4, 5 and 6.

First of all, a generic detector collects various items of information on an individual who is in its measurement zone, such as for example his speed of movement, his trajectory and certain characteristics of his behaviour. For this, a generic detector detects initially the possible presence of an individual in its measurement zone, for example by virtue of a presence detector 22. This involves a physical sensor, such as for example an infrared barrier. The presence of an individual is then detected when the latter cuts an infrared beam. A generic detector is also capable of detecting at least one physical signature of an individual in its measurement zone, by virtue of at least one signature detector 21 for example. For example, the signature detector 21 can be a camera making it possible to detect the face of an individual in its measurement zone without the collaboration of the individual. A generic detector is finally capable of detecting at least one threat represented by an individual in its measurement zone, by virtue of a threat detector 20. This is a physical sensor, such as for example a detector of metals, of traces of precursors in the manufacture of explosives or else of objects hidden under clothing.

Then, a generic detector is capable of sending to the supervisor 7 reports containing notably the results of estimating a level of threat, the estimation being carried out by a computing module 23 based on the measurements taken by the detector 20.

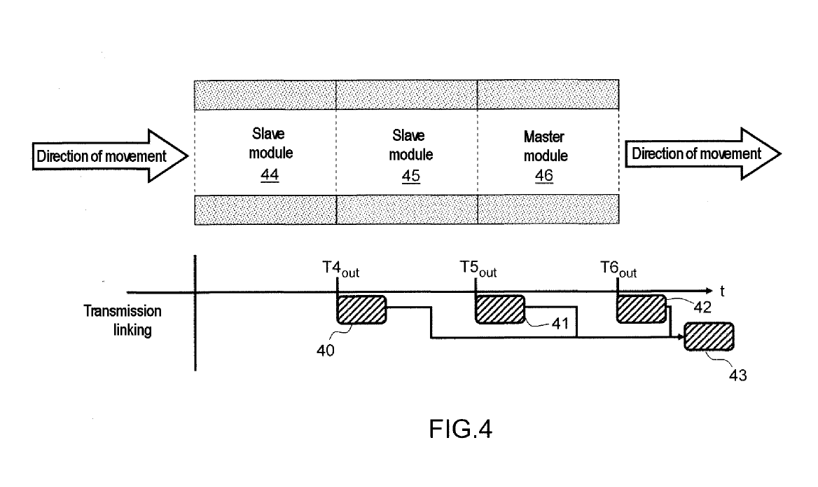

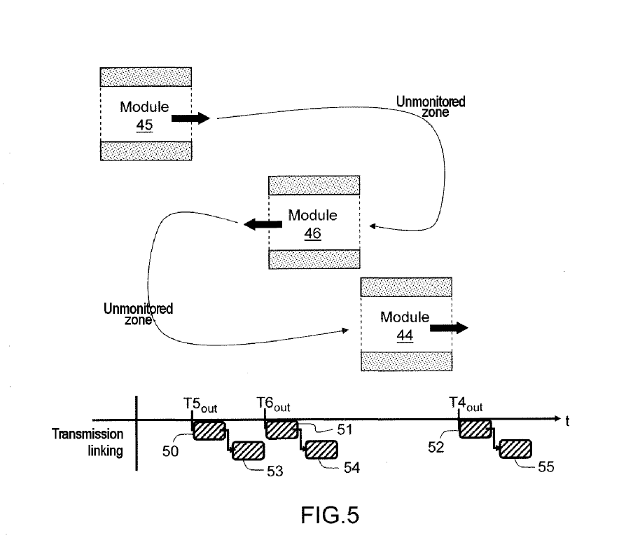

On receipt of the reports sent by the generic detectors 4, 5 and 6, the supervisor 7 carries out various tasks. He is notably responsible for linking the reports to the individual concerned. In one particular embodiment, the supervisor 7 can carry out this linking with the aid of the physical signature of the individual measured by the camera 21 and incorporated into the report, and with the aid of the database of the individuals updated by the enrolment station 3, this database linking the physical signature of the individual with his identifier. The supervisor 7 also makes it possible to spatially configure the system 1. Specifically, an important advantage of the multi-threat detection system 1 according to the invention is its modularity, the system 1 being able notably to be used in the two spatial configurations of the generic detectors 4, 5 and 6 illustrated by FIGS. 4 and 5. The choice of the spatial configuration of the generic detectors 4, 5 and 6 depends on the arrangement of the location to be protected.

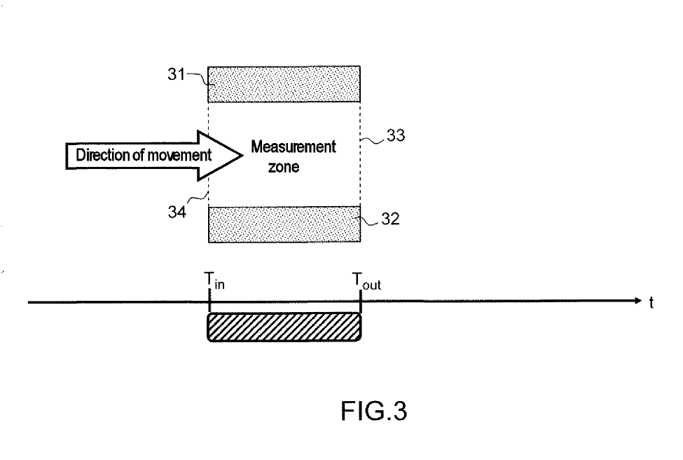

FIG. 3 illustrates, via a schematic and a timing chart, an example of a measurement zone of any one of the generic detectors 4, 5 or 6 according to the invention. The zone can be delimited by material and/or immaterial barriers. For example, the measurement zone can be delimited by two wooden panels 31 and 32 and by two infrared beams 33 and 34. The generic detector processes only the measurements taken when an individual moves in the direction of the arrow into the measurement zone between the moment Tᵢₙ of entry into the zone and the moment Tₒᵤₜ of exit from the zone. The duration of the process for processing the measurements between the moments Tᵢₙ and Tₒᵤₜ is illustrated by the cross-hatched rectangle. The same symbolism will be used to represent process durations in FIGS. 4, 5, 7, 8 and 9. In the rest of the present application, the assembly formed by a generic detector and the material and/or immaterial barriers delimiting its zone of measurement will be called the “measurement module”.

FIG. 4 illustrates, via a schematic and via a timing chart, an example of sequential configuration of measurement modules 44, 45 and 46 including the generic detectors 4, 5 and 6 respectively according to the invention. In this configuration, the measurement modules are placed so that an individual passes successively and directly from one measurement zone to another. The generic detectors 4, 5 and 6 process only the measurements taken when the individual moves in the direction of the arrow into their respective measurement zones, the individual leaving said zones at the moments T4ₒᵤₜ, T5ₒᵤₜ and T6ₒᵤₜ respectively. At the moment T4ₒᵤₜ, the measurement module 44 begins to send its report. A cross-hatched rectangle 40 beginning at the moment T4ₒᵤₜ illustrates the duration of this transmission. At the moment T5ₒᵤₜ, the measurement module 45 begins to send its report. A cross-hatched rectangle 41 beginning at the moment T5ₒᵤₜ illustrates the duration of this transmission. At the moment T6ₒᵤₜ, the measurement module 46 begins to send its report. A cross-hatched rectangle 42 beginning at the moment T6ₒᵤₜ illustrates the duration of this transmission. In the present example of sequential configuration, the measurement module 46 is the master module while the measurement modules 44 and 45 are slave modules. This means that the supervisor 7 attempts to link the reports received from the measurement modules 44, 45 and 46 only once for all of them when he has finished receiving in its totality the report sent by the master module 46. A cross-hatched rectangle 43 illustrates the duration of this linking.

FIG. 5 illustrates, via a schematic and via a timing chart, an example of non-sequential configuration of the measurement modules 44, 45 and 46 according to the invention. The measurement modules 44, 45 and 46 are stand-alone and separated by unmonitored zones. For example, the individual first crosses the measurement module 45, then the measurement module 46 and finally the measurement module 44, this order depending only on his intentions. At the moment T5ₒᵤₜ, the measurement module 45 begins to send its report. A cross-hatched rectangle 50 beginning at the moment T5ₒᵤₜ illustrates the duration of this transmission. At the moment T6ₒᵤₜ, the measurement module 46 begins to send its report. A cross-hatched rectangle 51 beginning at the moment T6ₒᵤₜ illustrates the duration of this transmission. At the moment T4ₒᵤₜ, the measurement module 44 begins to send its report. A cross-hatched rectangle 52 beginning at the moment T4ₒᵤₜ illustrates the duration of this transmission. In non-sequential configuration, the supervisor 7 attempts to link the reports received from the measurement modules 45, 46 and 44 each time he has finished receiving a report in its totality, whether it be the report from the measurement module 45, 46 or 44. Cross-hatched rectangles 53, 54 and 55 illustrate respectively the duration of these linkings.

FIG. 6 illustrates, via a schematic, an example of structure of a generic report 60 according to the invention. The generic report 60 encapsulates in a standard format the results originating from one or more threat detections made by the generic detector 4, 5 or 6 in its measurement zone. The encapsulation of the results is carried out after an individual has entered the measurement zone of the generic detector. The generic report 60 combines various elements of data.

The generic report 60 may notably comprise an element 67 including the date the report is created. This information can make archiving and processing of the reports easier. It can for example allow the supervisor 7 to file the reports by date of creation.

The generic report 60 may also comprise an element 68 including the identifier(s) of the threat detector(s). The supervisor 7 can use these items of information to interpret the data originating from the threat detection.

The generic report 60 may also comprise an element 69 combining the results of the presence detection, as illustrated by elements 70 and 71 for the moments of entry into and of exit from the measurement zone and the speed of movement respectively.

The generic report 60 may also comprise an element 64 combining the results of one or of more signature detections. These may be the results of biometric detections, as illustrated by elements 65 and 66 for the detection of the face and of the position of the eyes respectively. But it may also be an RFID solution or any other non-collaborative solution.

The generic report 60 may finally comprise an element 61 combining the results of the threat detection(s). The element 61 may notably comprise an element 62 which can itself combine one or more “business” estimates of the level(s) of threat. The result of an estimate of a level of threat may take the form of a value of between 0 and 100, this scale being arbitrary. The computation of this value can be carried out by an automated process responsible for interpreting raw data combined in an element 63 and corresponding to the measurements taken when the individual enters the measurement zone. These raw data 63 may also be used by the supervisor 7 as additional information, for example in order to determine more precisely the nature of the threat or else as elements of comparison with the results of another generic detector for the purpose of merging the data. For this, the raw data 63 may be encoded with the aid of a codec specific to the type of data, then sent to the supervisor 7 in the form of vectors. The supervisor 7 is then responsible for decoding the vectors with the aid of the same codec.

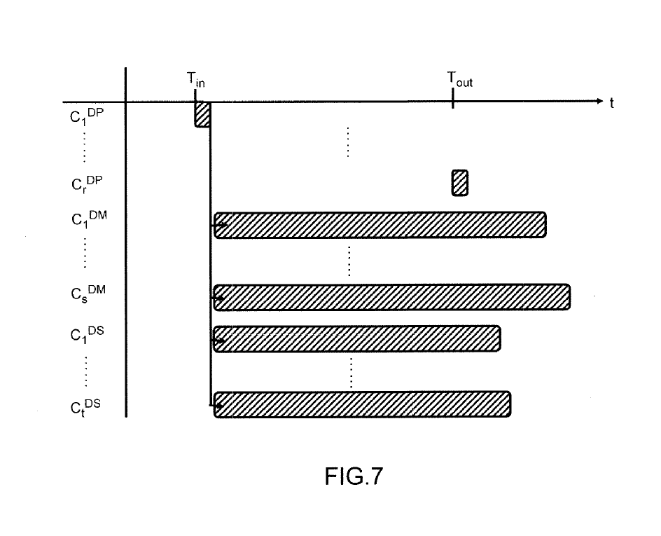

FIG. 7 illustrates, via a timing chart, examples of detection processes carried out by n threat detectors, where n is a non-zero integer, placed within one and the same generic detector. In the present exemplary embodiment, each generic detector comprises infrared barriers connected to an acquisition card for detecting the presence of an individual in its measurement zone, a detector specific to the threat to be detected, such as a metal detector or a detector of traces of precursors of explosives or of objects hidden under clothing, a biometric device for detecting the face and the eyes in a non-collaborative manner, and a low-resolution CCD (Charge-Coupled Device) camera. An individual first enters the measurement zone of the generic detector 1, then immediately the measurement zone of the generic detector 2, and so on until he finally enters the measurement zone of the generic detector n. As explained above, each generic detector i, where iε{1, . . . , n}, is capable of carrying out several processes of presence detection Cₓ^{DP}, where xε{1, . . . , r}, several processes of threat detection C_{y}^{DM}, where yε{1, . . . , s}, and several processes of signature detection C_{z}^{DS}, where zε{1, . . . , t}. As explained above, these detection processes are carried out only based on measurements taken when the individual enters the measurement zone of the detector i. For example, the individual enters the measurement zone of the detector 1 in the time interval [Tᵢₙ, Tₒᵤₜ]. As illustrated by FIG. 7, these detection processes require more or less long response times, which must be taken into consideration in order to prevent loss of information. In particular, as illustrated by FIG. 7, the processes of threat detection C₁^{DM} and of signature detection C₁^{DS} by the generic detector 1 can be continued after the moment Tₒᵤₜ when the individual leaves the measurement zone of the generic detector 1. It is therefore not possible for the generic detector 1 to send the totality of the report while the individual has left its measurement zone.

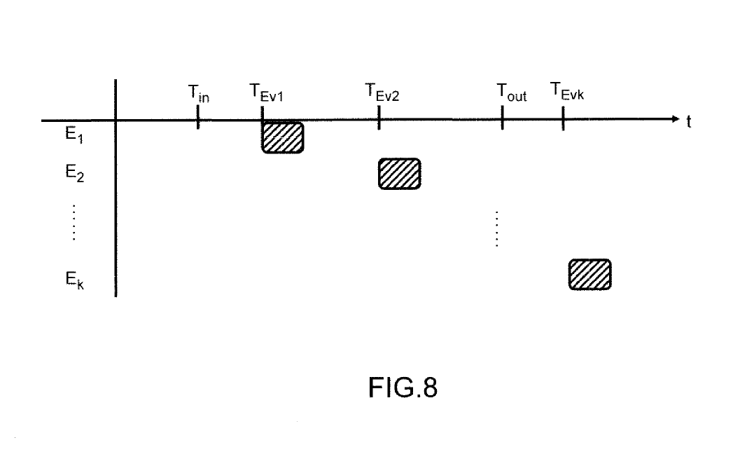

FIG. 8 illustrates, via a timing chart, examples of processes of the sending of a report by the generic detector 1 according to the invention. The individual enters the measurement zone of the detector 1 in the time interval [Tᵢₙ, Tₒᵤₜ]. As explained above, it may not be possible for the generic detector 1 to send a report as soon as the individual has left its measurement zone, said detector 1 not yet having completed its threat detection process C₁^{DM} and signature detection process C₁^{DS} at the moment T_{Ev1}, where T_{Ev1}=Tₒᵤₜ+ΔT_{DP2} and where ΔT_{DP2} is the response time of the presence detection process C₂^{DP}. To remedy this, the detector 1 can advantageously send in k portions, where k is a non-zero integer, a generic report like the generic report 60 described in relation to FIG. 6. The number k of portions depends on the triggering events available Evk. These may be detection events such as the individual exiting from the measurement zone, a sufficient quantity of data or else an alarm. These may also be systems events such as anomalies. Finally these may be temporal events such as the expiry of a delay. Therefore, as illustrated by FIG. 8, when the event Evk occurs at the moment T_{Evk}, a process Eₖ of transmitting a k^{th} portion of report begins.

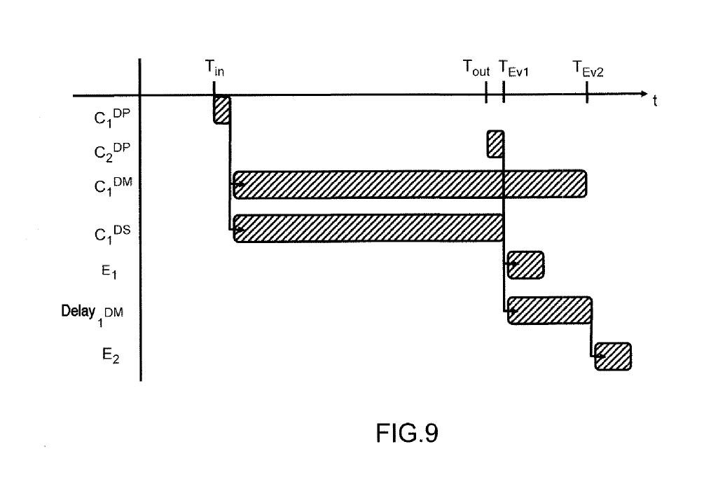

FIG. 9 illustrates, via a timing chart, an example of the sending by the generic detector 1 of a report in two portions. The individual enters the measurement zone of the detector 1 in the time interval [Tᵢₙ, Tₒᵤₜ]. The detection of the individual exiting from the measurement zone at the moment T_{Ev1} is the first triggering event triggering a first transmission process E₁. The first portion includes all of the biometric and location results, and a portion of the results of the threat detection. The end of the execution delay of the longest detection process carried out by the detector 1, which is the threat detection process C₁^{DM} in the present exemplary embodiment, is the second triggering event triggering a second transmission process E₂. The threat detection process C₁^{DM} ends no later than the expiry of a delay ΔTₘₐₓ starting from the moment Tₒᵤₜ, the delay ΔTₘₐₓ corresponding to the largest volume of data that C₁^{DM} can be made to process. This is why the generic detector 1 executes, from the moment Tₒᵤₜ, a waiting process Delay₁^{DM} making it possible to delay the beginning of the process E₂ by a duration ΔTₘₐₓ up to the moment T_{Ev2}. The second portion includes the results obtained during the delay of execution of the threat detection.

The main advantages of the invention described above are also that it makes it possible to send threat detection results in a generic format to the supervisor, thus promoting the open-endedness of the system. Moreover, the invention makes it possible to link the threat-detection results to the results of detection of the signature of the individual. Finally, a multi-threat detection system constructed on the basis of generic detectors according to the invention can be used in a “chained” spatial configuration up to very high flow rates in which each measurement zone is permanently traversed by an individual.

1. A device having at least one threat detector for estimating the level of threat represented by an individual based on measurements taken when the individual goes through a measurement zone, the device comprising:
at least one physical-signature detector taking measurements in the measurement zone in order to recognize the individual if the latter is known in a database of the individuals likely to go through the measurement zone, the database containing, for each of said individuals, an identifier associated with his physical signature that can be recognized by the physical-signature detector, the device sending a report according to a predetermined format irrespective of the type of measurements taken and of the nature of the estimated threat, wherein the report is sent in several distinct portions so that the transmission of the data can begin before the detections of threat and of physical signature are completed.

2. A device according to claim 1, further comprising a presence detector in order to detect the presence of the individual in the measurement zone.

3. A device according to claim 2, wherein the presence detector comprises an infrared beam which the individual breaks when he enters the measurement zone and an infrared beam which the individual breaks when he leaves the measurement zone.

4. A device according to claim 1, wherein the threat detector detects:
metals that can be carried by the individual, or;
traces of precursors in the manufacture of explosives that can be carried by the individual, or;
objects that can be hidden under the clothing of the individual.

5. A device according to claim 1, wherein the physical-signature detector is a camera capable of detecting the face of the individual.

6. A device according to claim 1, wherein the report contains the raw measurements taken when the individual goes through the measurement zone and the estimated level of threat based on these measurements.
